(19) United States
(12) Patent Application Publication
(10) Pub. No.: US 2008/0049704 A1
(43) Pub. Date: Feb. 28, 2008

(54) PHONE-BASED BROADCAST AUDIO IDENTIFICATION

(75) Inventors: Bradley James Witteman, La Jolla, CA (US); Robert Reid, San Diego, CA (US)

Correspondence Address: FISH & RICHARDSON, PC, P.O. BOX 1022, MINNEAPOLIS, MN, 55440-1022, US

(73) Assignee: Skyclix, Inc.

(21) Appl. No.: 11/674,015

(22) Filed: Feb. 12, 2007

Related U.S. Application Data
(60) Provisional application No. 60/840,194, filed on Aug. 25, 2006.

(51) Int. Cl. H04B 7/216

(52) U.S. Cl. 370/342

(57) ABSTRACT

This specification describes technologies relating to a phone-based system for identifying broadcast audio streams, and methods of providing such a system. In one aspect, a method includes receiving a plurality of broadcast streams, each from a corresponding broadcast source and generating a first broadcast audio identifier based on a first broadcast stream of the plurality of broadcast streams. The method also includes storing for a selected temporary period of time the first broadcast audio identifier. The method further includes receiving a user-initiated telephone connection; and generating a user audio identifier. Other implementations of this aspect include corresponding systems, apparatus, and computer program products.

### PRIOR APPLICATIONS

This application claims priority to U.S. application Ser. No. 60/840,194, filed on Aug. 25, 2006. The disclosure of the prior application is considered part of the disclosure of this application and is incorporated by reference in its entirety.

### BACKGROUND

The subject matter described herein relates to a phone-based system for identifying broadcast audio streams, and methods of providing such a system.

Systems are currently available for identifying broadcast audio streams received by a user. In order to provide such audio identification, these conventional systems are typically based either on the creation and maintenance of a database library of audio fingerprints for each piece of content to be identified, or the insertion of a unique piece of data (i.e., an audio watermark) into the broadcast audio stream. An example of a conventional system based on the creation and maintenance of a database library of audio fingerprints is such a system provided by Gracenote (formerly, CDDB or Compact Disc Database). The database in Gracenote's system includes fingerprints of audio CD (compact disc) information. With this database, Gracenote provides software applications that can be used to look up audio CD (compact disc) information stored on the database over the Internet.

### SUMMARY

The present inventor recognized the deficiencies with conventional broadcast audio identification systems using database libraries of audio fingerprints for each piece of content to be identified. For example, broadcast audio can include portions of a program that are more dynamic, such as the advertising and live broadcast (e.g., talk shows and live musical performances that are performed at a broadcast studio). With conventional broadcast audio identification systems, broadcast audio streams that consist of live broadcasts and advertising information can be difficult to identify because they rely on the identification of the broadcast audio stream against a library of pre-processed audio content.

Furthermore, conventional broadcast identification systems typical require a different library of pre-processed audio content for each spoken language. Thus, different versions of a song in different spoken languages need to be stored in different database libraries, which can be inefficient, time-consuming and difficult when language translation software is not available. Consequently, the present inventor developed the systems and methods described herein that provide flexibility, efficiency and scalability compared to conventional systems.

In one aspect, a method includes receiving a plurality of broadcast streams, each from a corresponding broadcast source and generating a first broadcast audio identifier based on a first broadcast stream of the plurality of broadcast streams. The method also includes storing for a selected temporary period of time the first broadcast audio identifier. The method further includes receiving a user-initiated telephone connection; and generating a user audio identifier. Other implementations of this aspect include corresponding systems, apparatus, and computer program products.

Variations may include one or more of the following features. For example, the method can include reporting periodically a status of receiving the plurality of broadcast streams. The method can also include generating a second broadcast audio identifier based on the first broadcast stream. The method can further include generating a third broadcast audio identifier based on a second broadcast stream of the plurality of broadcast streams and storing for the selected temporary period of time the second and the third broadcast audio identifiers.

The act of generating the first broadcast audio identifier can include generating a first broadcast fingerprint of a first portion of the first broadcast stream; retrieving a first metadata from the first portion of the first broadcast stream; and associating a first broadcast timestamp with the first broadcast fingerprint. The act of generating the second broadcast audio identifier can include generating a second broadcast fingerprint of a second portion of the first broadcast stream, retrieving a second metadata from the second portion of the first broadcast stream, and associating a second broadcast timestamp with the second broadcast fingerprint. The act of generating the third broadcast audio identifier can include generating a third broadcast fingerprint of a first portion of the second broadcast stream; retrieving a third metadata from the first portion of the second broadcast stream; and associating the first broadcast timestamp with the third broadcast fingerprint. The method can also include retrieving the first, second or third broadcast audio identifier that most closely corresponds to the user audio identifier.

The act of generating the user audio identifier can include receiving an audio sample through the user-initiated telephone connection for a predetermined period of time. The act of generating the user audio identifier can also include generating a user audio fingerprint of the audio sample, and associating a user audio timestamp with the user audio fingerprint. The act of generating the user audio identifier can further include retrieving telephone information through the user-initiated telephone connection. The selected temporary period of time can be less than about 20 minutes. Alternatively, the selected temporary period of time can be more than 20 minutes, such as 30 minutes, an hour, or 20 hours if system design constraints require such an increase in time, e.g., for those situations where a user records a live broadcast stream, such as a favorite talk show, and then listens to the recording some time later. The corresponding broadcast source can be, e.g., a radio station, a television station, an Internet website, an Internet service provider, a cable television station, a satellite radio station, a shopping mall, a store, or any other broadcast source known to one of skill.

The second broadcast timestamp can be separated from the first broadcast timestamp by a time interval, such as about 5 seconds. Alternatively, the time interval can be more or less than 5 seconds, such as a 1 or 2 second interval or 10 second interval, if system design constraints require such a different time interval. The method can also include obtaining the first, the second, or the third metadata associated with the retrieved broadcast audio identifier, and transmitting a message based on the obtained metadata. This message can be a text message, an e-mail message, a multimedia message, an audio message, a wireless application protocol message, a data feed, or any other message known to one or skill. The first, second and third metadata can be provided by a metadata source, such as a radio broadcast data standard (RBDS) broadcast stream, a radio data system (RDS) broadcast stream, a high definition radio broadcast stream, a vertical blanking interval (VBI) broadcast stream, a digital audio broadcasting (DAB) broadcast stream, a MediaFLO broadcast stream, closed caption broadcast stream, or any other metadata source known to one of skill.

The predetermined period of time can be less than about 25 seconds. Alternatively, the predetermined period of time can be more than 25 seconds if design constraints require the predetermined period of time to be more. The telephone information can include a group of an automatic number identifier (ANI), a carrier identifier (Carrier ID), a dialed number identification service (DNIS), an automatic location identification (ALI), and a base station number (BSN), or any other telephone information known to one of skill. The method can include selecting either the first, second, or third broadcast fingerprint, that most closely corresponds to the user fingerprint. The act of selecting can include selecting either the first or second broadcast timestamp that most closely corresponds to the user timestamp, retrieving each broadcast fingerprint associated with the selected broadcast timestamp, comparing each retrieved broadcast fingerprint to the user fingerprint, and retrieving one of the compared broadcast fingerprints that most closely corresponds to the user fingerprint.

In another aspect, a method includes generating a broadcast stream having more than one broadcast segment, each broadcast segment including metadata. The method also includes associating each broadcast segment with a broadcast timestamp. The method further includes receiving a user-initiated telephone connection, and generating a user audio identifier. Other implementations of this aspect include corresponding systems, apparatus, and computer program products.

In one variation, the act of generating the user audio identifier can include receiving an audio sample through the user-initiated telephone connection for a predetermined period of time. The act of generating the user audio identifier can also include associating a user audio timestamp with the audio sample, and retrieving telephone information through the user-initiated telephone connection. The predetermined period of time can be less than about 25 seconds. Alternatively, the predetermined period of time can be more than 25 seconds if design constraints require the predetermined period of time to be more. The telephone information can include at least one selected from a group of an automatic number identifier (ANI), a carrier identifier (Carrier ID), a dialed number identification service (DNIS), an automatic location identification (ALI), and a base station number (BSN), or any other telephone information known to one of skill.

The method can also include selecting one of the associated broadcast timestamps that most closely corresponds to the user audio timestamp, and retrieving the broadcast segment associated with the selected broadcast timestamp. The method can further include obtaining the metadata from the retrieved broadcast segment, and transmitting a message based on the obtained metadata. The transmitted message can be any message known to one of skill, such as those noted above. The metadata also can be provided by any known metadata source, such as those noted above.

In a further aspect, a system includes a broadcast server and a computer program product stored on one or more computer readable mediums. The computer program product includes executable instructions configured to cause the broadcast server to, e.g., receive one or more broadcast streams from a broadcast source or from multiple broadcast sources, generate a first broadcast audio identifier based on a first broadcast stream, and store for a selected temporary period of time the first broadcast audio identifier.

In one variation, the system also includes an audio server configured to communicate with the broadcast server. The computer program product further includes executable instructions configured to cause the audio server to, e.g., receive a user-initiated telephone connection, and generate a user audio identifier, which may include the audio server to receive an audio sample through the user-initiated telephone connection for a predetermined period of time, generate a user audio fingerprint of the audio sample, associate a user audio timestamp with the user audio fingerprint, and retrieve telephone information through the user-initiated telephone connection.

The executable instructions can also cause the audio server to generate a second broadcast audio identifier based on the first broadcast stream, generate a third broadcast audio identifier based on a second broadcast stream, and store the second and third broadcast audio identifiers for the selected temporary period of time. To generate the first broadcast audio identifier based on the first broadcast stream, the audio server can, e.g., generate a first broadcast fingerprint of a first portion of the first broadcast stream, retrieve a first metadata from the first portion of the first broadcast stream, and associate a first broadcast timestamp with the first broadcast fingerprint. To generate the second broadcast audio identifier based on the first broadcast stream, the audio server can, e.g., generate a second broadcast fingerprint of a second portion of the first broadcast stream, retrieve a second metadata from the second portion of the first broadcast stream, and associate a second broadcast timestamp with the second broadcast fingerprint.

To generate the third broadcast audio identifier based on the second broadcast stream, the audio server can, e.g., generate a third broadcast fingerprint of a first portion of the second broadcast stream, retrieve a third metadata from the first portion of the second broadcast stream, and associate the first broadcast timestamp with the third broadcast fingerprint. The executable instructions can also cause the audio server to retrieve the first, second or third broadcast audio identifier that most closely corresponds to the user audio identifier. The system can further include a commerce server configured to communicate with the broadcast server. The computer program product can further executable instructions configured to cause the commerce server to, e.g., transmit a message, such as any of those noted above, to a user based on the retrieved broadcast audio identifier.

Other computer program products are also described. Such computer program products can include executable instructions that cause a computer system to conduct one or more of the method acts described herein. Similarly, the systems described herein can include one or more processors and a memory coupled to the one or more processors. The memory can encode one or more programs that cause the one or more processors to perform one or more of the method acts described herein. These general and specific aspects can be implemented using a system, a method, or a computer program, or any combination of systems, methods, and computer programs.

The systems and methods described herein can, e.g., cache broadcast audio streams in real-time and retrieve the broadcast information (e.g., metadata, RBDS and HD Radio information) associated with the cached broadcast audio streams. Further, the system can, e.g., identify what station or channel and what kind of audio a user is listening to by comparing an audio sample taken of a live broadcast provided by the user through his phone (e.g., a mobile or land-line phone) with the cached broadcast stream and retrieving audio identification information from the cache. Thus, broadcast audio content including prepared content and dynamic content such as advertising, live performances, and talk shows, can be identified.

The systems and methods described herein can provide one or more of the following advantages. For example, they offer the ability to identify dynamic broadcast content, such as advertisement and live broadcast, in addition to pre-recorded broadcast content, do not require libraries of audio content, and facilitate scalable deployment in geographic regions having different broadcast markets or different languages. Additionally, the systems and methods described herein can be utilized to cache and identify broadcast audio streams from a variety of broadcast sources, such as terrestrial broadcast sources, cable broadcast sources, satellite broadcast sources, or Internet broadcast sources. Rather than relying on a database library of samples and pre-screening all content to be identified, this system uses servers to receive and cache (i.e., store temporarily in a non-persistent manner), for example, fifteen minutes of live broadcast audio streams so that a user's request need only be compared to the pool of possible broadcast audio streams in a geographic area associated with the servers.

Moreover, the systems and methods can be more efficient and require less computational resources because broadcast audio identification is compared with a limited number of broadcast sources (e.g., a limited number of radio or television stations) in a broadcast market; rather than the much longer search time needed to make a match based on searching a library of potentially hundreds of thousands of songs. Furthermore, the systems and methods described herein can enable other business models based on a catalog of the broadcast information identified from the broadcast content. Also, the systems and methods do not depend on deployment of equipment at any broadcast source because servers can be tuned into the broadcast audio streams in a particular geographic region. In this manner, the systems and methods can be flexible and scalable because it does not rely on the broadcasters' modifying their business processes. Additionally, because of the method of identification, there is no requirement to preprocess the audio catalogs in various languages or markets, but rather, international expansion can be as easy as deploying a set of server clusters into that geographic region.

Other aspects, features, and advantages will become apparent from the following detailed description, the drawings, and the claims.

### BRIEF DESCRIPTION OF THE DRAWINGS

FIG. 1 is a conceptual diagram of a system that can analyze audio samples obtained from a live broadcast and deliver personalized, interactive messages to the user.

FIG. 2 illustrates a schematic diagram of a system that can identify broadcast audio streams from various broadcast sources in a geographic region.

FIG. 3A is a flow chart showing a method for providing broadcast audio identification.

FIG. 3B is a now chart showing a method for comparing a user audio identifier (UAI) to a cached broadcast stream audio identifiers (BSAIs).

FIG. 4 illustrates conceptually a method for generating broadcast fingerprints of a single broadcast stream.

FIG. 5 shows an example comparison of a user fingerprint to a broadcast fingerprint.

FIG. 6A shows an example of a wireless access protocol (WAP) message that can be displayed on a user's phone to allow a user to rate the audio sample and contact the broadcast source.

FIG. 6B shows another example of a WAP message that can be displayed on a user's phone to allow a user to purchase an identified song or buy a ringtone.

FIG. 6C shows yet another example of a WAP message including a coupon that can be displayed on a user's phone and used by the user in a future transaction.

FIG. 7 shows conceptually a method for generating and comparing user audio fingerprints and broadcast fingerprints.

FIG. 8 is a flow chart showing another method for providing broadcast audio identification.

Like reference symbols in the various drawings indicate like elements.

### DETAILED DESCRIPTION

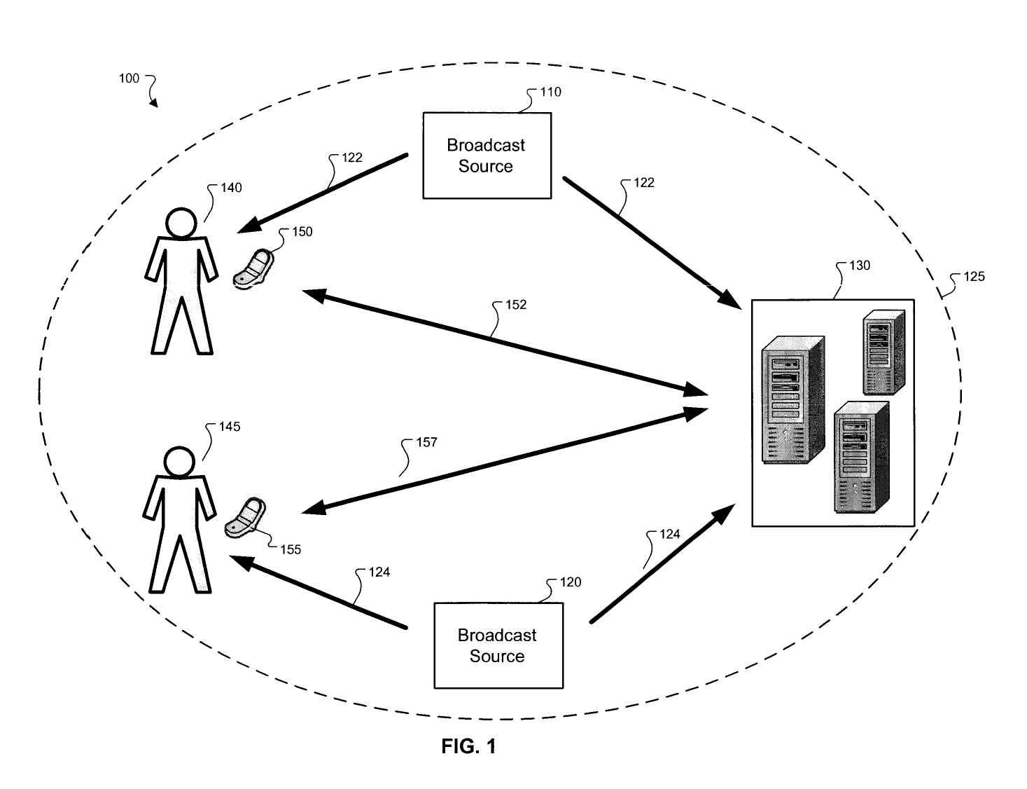

FIG. 1 is a conceptual diagram of a system 100 that can analyze audio samples obtained from a live broadcast, such as broadcast stream 122, from a broadcast audio source, e.g., 110, via a user's phone, e.g., 150, and deliver via a communication link, e.g., 152, personalized, interactive messages to the user's phone, e.g., 150. The system and its associated methods permit users to receive personalized broadcast information associated with broadcast streams that are both current and relevant. It is current because it reflects real-time broadcast information. It is relevant because it can provide interactive information that are of interest to the user, such as hyperlinks and coupons, based on the audio sample without requiring the user to recognize or enter detailed information about the live broadcast from which the audio sample is taken.

In a given geographic region (e.g., a metropolitan area, a town, or a city), there can be various broadcast audio sources 110, 120, such as radio stations, television stations, satellite radio and television stations, cable companies and the like. Each broadcast audio source 110, 120 can transmit one or more audio broadcast streams 122, 124, and some broadcast audio sources 110, 120 can also provide video streams (not shown). A broadcast audio stream (or broadcast stream) 122, 124 includes an audio component (broadcast audio) and a data component (metadata), which describes the content of the audio component. As shown in FIG. 1, broadcast sources 110, 120 each transmits a corresponding broadcast stream 122, 124 in a geographic region 125. A server cluster 130, which can include multiple servers in a distributed system or a single server, is used to receive and cache the broadcast streams 122, 124 from all the broadcast sources in the geographic region 125. The server cluster 130 can be deployed in situ or remotely from the broadcast sources 110, 120. In the case of a remote deployment, the server cluster 130 can tune to the broadcast sources 110, 120 and cache the broadcast streams 122, 124 in real time as the broadcast streams 122, 124 are received. In the case of an in situ deployment, a server of the server cluster 130 is deployed in each of the broadcast sources 110, 120 to cache the broadcast streams 122, 124 in real time, as each broadcast stream 122, 124 is transmitted.

In addition to caching (i.e., temporarily storing) the broadcast streams 122, 124, the server cluster 130 also processes the cached broadcast streams into broadcast fingerprints for portions of the broadcast audio. Each portion (or segment) of the broadcast audio corresponds to a predefined duration of the broadcast audio. For example, a portion (or segment) can be predefined to be 10 seconds or 20 seconds or some other predefined time duration of the broadcast audio. These broadcast fingerprints are also cached in the server cluster 130.

Users, e.g., users 140, 145, who are tuned to particular broadcast channels of the broadcast sources 110, 120 may want more information on the broadcast audio stream that they are listening to or just heard. As an example, user 140 may be listening to a song on broadcast stream 122 being transmitted from the broadcast source 110, which could be pre-recorded or a live performance by the artist at the studio of the broadcast source 110. If the user 140 really likes the song but does not recognize it (e.g., because the song is new) and would like to obtain more information about the song, the user 140 can then use his phone 150 to connect with the server cluster 130 via a communications link 152 and obtain metadata associated with the song. The communications link 152 can be a cellular network, a wireless network, a satellite network, an Internet network, some other type of communications network or combination of these. The phone 150 can be a mobile phone, a traditional landline-based telephone, or an accessory device to one of these types of phones.

By using the phone 150, the user 140 can relay the broadcast audio via the communications link 152 to the server cluster 130. A server in the server cluster 130, e.g., an audio server, samples the broadcast audio relayed to it from the phone 150 via communications link 152 for a predefined period of time, e.g., about 20 seconds in this implementation, and stores the sample (i.e., audio sample). In other implementations, the predefined period of time can be more or less than 20 seconds depending on design constraints. For example, the predefined period of time can be 5 seconds, 10 seconds, 24 seconds, or some other period of time.

The server cluster 130 can then process the audio sample into a user audio fingerprint and perform an audio identification by comparing this user fingerprint with a pool of cached broadcast fingerprints. In one implementation, the predefined portion of the broadcast audio provided by the user has the same time duration as the predefined portion of the broadcast stream cached by the server cluster 130. As an example, the system 100 can be configured so that a 10-second duration of the broadcast audio is used to generate broadcast fingerprints. Similarly, a 10-second duration of the audio sample is cached by the server cluster 130 and used to generate a user audio fingerprint.

Once an identification of the broadcast audio has been achieved, the server cluster 130 can deliver a personalized and interactive message to the user 140 via communications link 152 based on the metadata of the identified broadcast stream. This personalized message can include the song title and artist information, as well as a hyperlink to the artist's website or a hyperlink to download the song of interest. Alternatively, the message can be a text message (e.g., SMS), a video message, an audio message, a multimedia message (e.g., MMS), a wireless application protocol (WAP) message, a data feed (e.g., an RSS feed, XML feed, etc.), or a combination of these.

Similarly, the user 145 may be listening to the broadcast stream 124 being transmitted by the broadcast source 120 and wants to find out more about a contest for a trip to Hawaii that is being discussed. The user 145 can then use her phone 155, which can be a mobile phone, a traditional landline-based telephone, or an accessory device to one of these types of phones, to connect with the server cluster 130 via communications link 157 and obtain more in formation, such as metadata associated with the song, i.e., broadcast information. By using the phone 155, the user 145 can relay the broadcast audio via the communications link 157 to the server cluster 130. A server in the server cluster 130, e.g., an audio server, samples the broadcast audio relayed to it from the phone 155 via communications link 157 for a predefined period of time, e.g., about 20 seconds in this implementation, and stores the sample (i.e., audio sample). Again, in other implementations, the predefined period of time can be more or less than 20 seconds depending on design constraints. For example, the predefined period of time can be about 5 seconds, 10 seconds, 14 seconds, 24 seconds, or some other period of time.

As noted above, the personalized message can be in a form of a WAP message, which can include, e.g., a hyperlink to the broadcast source (e.g., the radio station) to obtain the rules of the contest. Additionally, the message can allow the user 145 to “scroll” back to an earlier segment of the broadcast by a predetermined amount of time, e.g., 30 seconds or some other period of time, in order to obtain information on broadcast audio that she might have missed. This feature in the interactive message can accommodate situations where the user just heard a couple of seconds of the contest, and by the time she dials-in or connects to the system 100, the contest info is no longer being transmitted.

In addition to the server cluster 130 (which is associated with the geographic region 125), other server clusters can be deployed to service other geographic regions. A superset of server clusters can be formed with each server cluster communicatively coupled to one another. Thus, when one server cluster in a particular geographic region cannot identify an audio sample taken from a broadcast stream that was relayed by a user via his phone, server clusters in neighboring geographic regions can be queried to perform the audio identification. Therefore, the system 100 can allow for situations where a user travels from one geographic region to another geographic region.

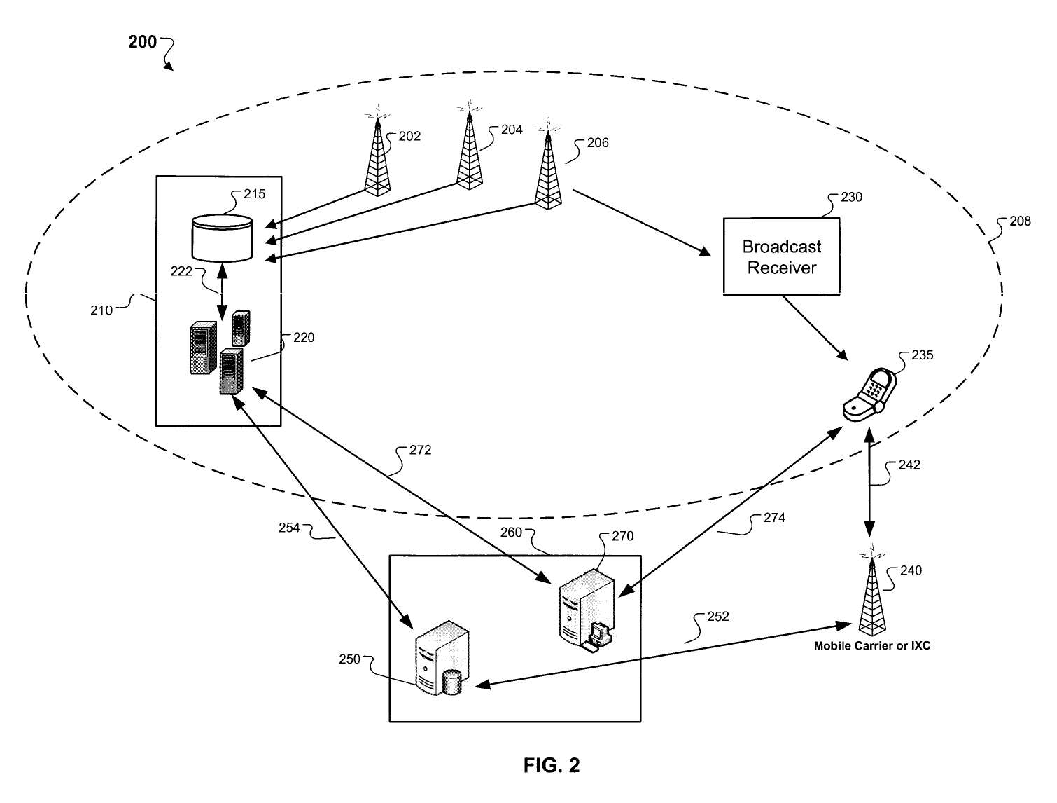

FIG. 2 illustrates a schematic diagram of a system 200 that can be used to identify broadcast streams from various broadcast sources 202, 204, and 206 in a geographic region 208. The broadcast sources 202, 204, and 206 can be any type of sources capable of transmitting broadcast streams, such as radios, televisions, Internet sites, satellites, and location broadcasts (e.g., background music at a mall). A server cluster 210, which includes a capture server 215 and a broadcast server 220, can be deployed in the geographic region 208 to record broadcast streams and deliver broadcast information (e.g., metadata) to users. In one implementation, the capture server 215 can be deployed remote from the broadcast sources 202, 204, and 206 and broadcast server 220, but still within the geographic region 208; on the other hand, the broadcast server 220 can be deployed outside of the geographic region 208, but communicatively coupled with the capture server 215 via a communications link 222.

The capture server 215 receives and caches the broadcast streams. Once the capture sever 210 has cached broadcast streams for a non-persistent, selected temporary period of time, the capture server 215 starts overwriting the previously cached broadcast streams in a first-in-first-out (FIFO) fashion. In this manner, the capture server 210 is different from a database library, which stores pre-processed information and intends to store such information permanently for long periods of time. Further, the most recent broadcast streams for the selected temporary period of time will be cached in the capture server 215. In one implementation, the selected temporary period of time can be configured to be about fifteen minutes and the capture server 210 caches the latest 15-minute duration of broadcast streams in the geographic region 208. In other implementations, the selected temporary period of time can be configured to be longer or shorter than 15 minutes, e.g., five minutes, 45 minutes, 3 hours, a day, or a month.

The cached broadcast streams can then be processed by the broadcast server 220 to generate a series of broadcast fingerprints, which is discussed in further detail below. Each of these broadcast fingerprints is associated with a broadcast timestamp, which indicates the time that the broadcast stream was cached in the capture server 215. The broadcast server 220 can also generate broadcast stream audio identifiers (BSAIs) associated with the cached broadcast streams. Each BSAI corresponds to a predetermined portion or segment (e.g., 20 seconds) of a broadcast stream, and can include the broadcast fingerprint, the broadcast timestamp and metadata (broadcast information) retrieved from the broadcast stream. The BSAIs are cached in the broadcast server 220 and can facilitate searching of an audio match generated from another source of audio.

A broadcast receiver 230 can be tuned by a user to one of the broadcast sources 202, 204, and 206. The broadcast receiver 230 can be any device capable of receiving broadcast audio, such as a radio, a television, a stereo receiver, a cable box, a computer, a digital video recorder, or a satellite radio receiver. As an example, suppose the broadcast receiver 230 is tuned to the broadcast source 206. A user listening to broadcast source 206 can then use her phone 235 to connect with the system 200, by, e.g., dialing a number (e.g., a local number, a toll free number, a vertical short code, or a short code), or clicking a link or icon on the phone's display, or issuing a voice or audio command. The user, via the user's phone 235, is then connected to a network carrier 240, such as a mobile phone carrier, an interexchange carrier (IXC), or some other network, through communications link 242.

After receiving connection from the user's phone 235, the phone carrier 240 then connects to the audio server 250, which is a part of the network operations center (NOC) 260, through communications link 252. The audio server 250 can obtain certain telephone information of the connection based on, e.g., the signaling system #7 (SS7) protocol, which is discussed in detail below. The audio server 250 can also sample the broadcast stream relayed by the user via the phone 235, cache the audio sample, and generate a user audio identifier (UAI) based on the cached audio sample. The audio server 250 then forwards the UAI to the broadcast server 220 via communications link 254 for an audio identification by performing a comparison between the UAI and a pool of cached BSAIs. The most highly correlated BSAI is then used to provide personalized broadcast information, such as metadata, to the user. Details of this comparison is discussed below.

The broadcast server 220 then sends relevant broadcast information based on the recognized BSAI to the commerce server 270, which is also a part of the NOC 270, via a communications link 272. A user data set, which can include the metadata from the recognized BSAI, the user timestamp, and user data (if any), is sent to the commerce server 270. The commerce server 270 can take the received user data set and generate an interactive and personalized message, e.g., a text message, a multimedia message, or a WAP message. In addition to the user data set, other information, such as referrals, coupons, advertisements, and instant broadcast source feedback can be included in the message. This interactive and personalized message can be transmitted via a communications link 274 to the user's phone 235 by various means, such as SMS, MMS, e-mail, instant message, text-to-speech through a telephone call, and voice-over-Internet-protocol (VoIP) call, or a data feed (e.g., an RSS feed or XML feed). Upon receiving the message from the commerce server 270, a user can, e.g., request more information or purchase the audio, e.g., by clicking on an embedded hyperlink.

Once the user's transaction is complete, the commerce server 270 can maintain all information except the actual source broadcast audio in a database for user behavior and advertiser tracking information. For example, in a broadcast database the system can store all of the broadcast fingerprints, the metadata and any other information collect during the audio identification process. In a user database the system can store all of the user fingerprints, the associated telephony information, and the audio identification history (i.e., the metadata retrieved after a broadcast audio sample is identified). In this manner, over time the system can build a fingerprint database of everything broadcast including the programming metadata, as well as a usage database of where, when, and what people were listening to.

In one implementation, the audio server 250 includes telephony line cards interfaced with the network carrier 240. In another implementation, the audio server 250 is outsourced to an IXC which can process audio samples, generate UAIs and relay the UAIs back to the NOC over a network connection. The audio server 250 can also include a user database that stores the user history and preference settings, which can be used to generate personalized messages to the user. The audio server 250 also includes a queuing system for sending UAIs to the broadcast server 220, a backup database of content audio fingerprints sourced from a third party, and a heartbeat and management tool to report on the status of the server cluster 210 and BSAI generation. The commerce server 270 can include an SMTP mail relay for sending SMS messages to the user's phone 225, an Apache web server (or the like) for generating WAP sessions, an interface to other web sites for commerce resolutions, and an interface to the audio server 250 to file user identification events to a database of user profiles.

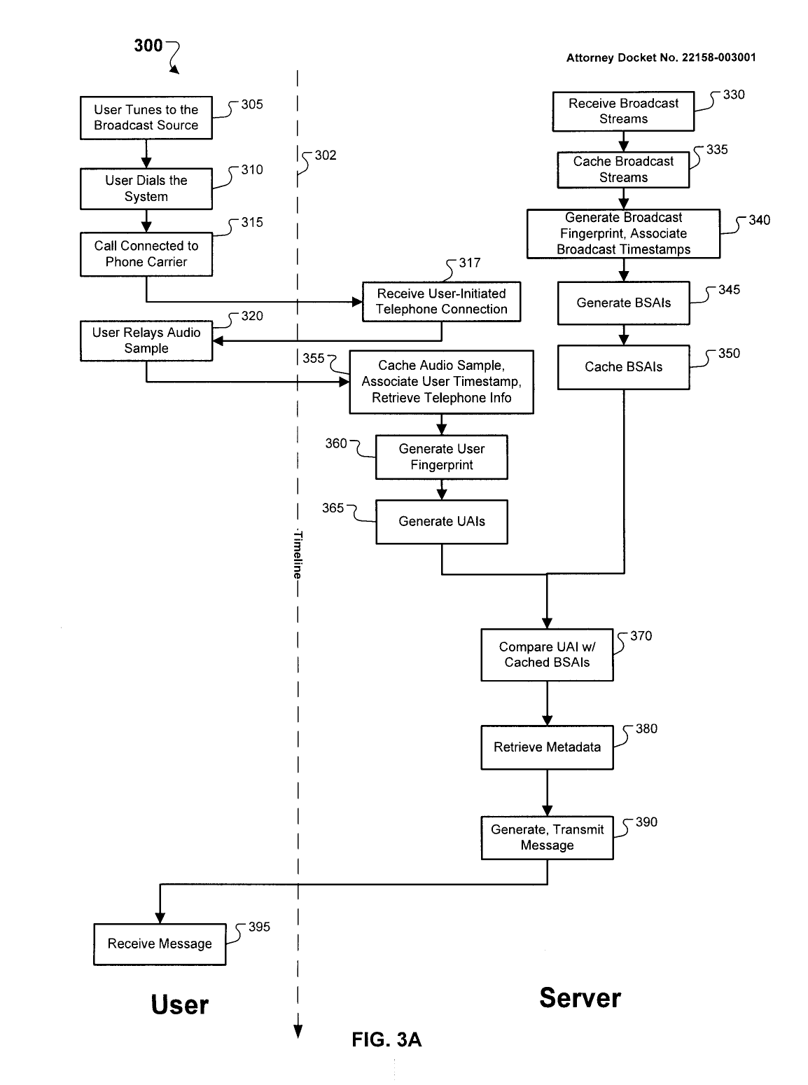

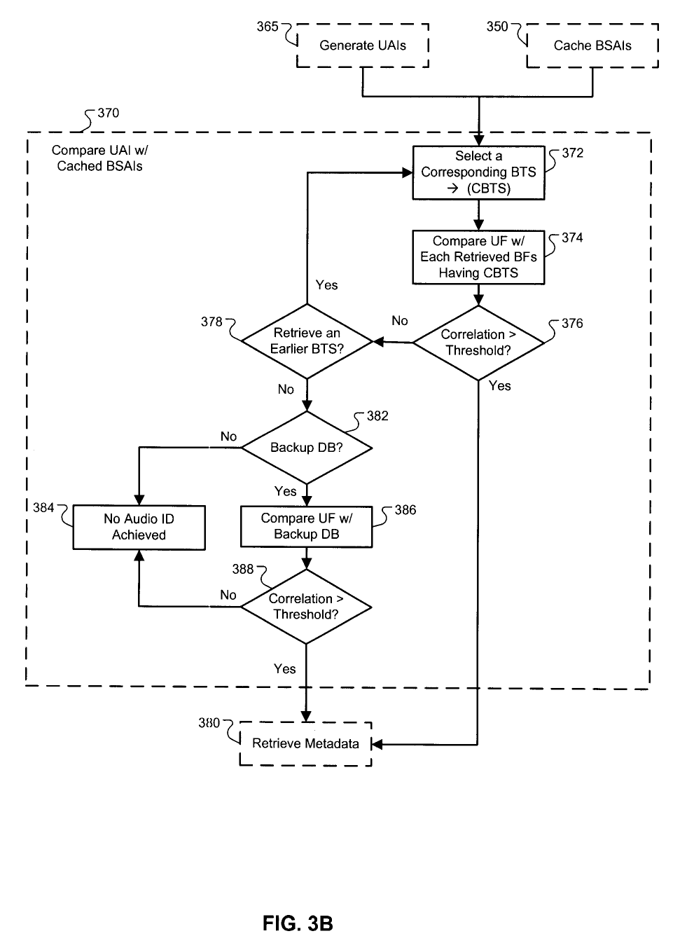

FIG. 3A is a flow chart showing a method 300 for providing broadcast audio identification based on audio samples obtained from a broadcast stream provided by a user through a user-initiated connection, such as by dialing-in. The steps of method 300 are shown in reference to a timeline 302; thus, two steps that are at the same vertical position along timeline 302 indicates that the steps can be performed at substantially the same time. In other implementations, the steps of method 300 can be performed in different order and/or at different times.

In this implementation, however, at 305, a user tunes to a broadcast source to receive one or more broadcast audio streams. This broadcast source can be a pre-set radio station that the user likes to listen to or it can be a television station that she just tuned in. Alternatively, the broadcast source can be a location broadcast that provides background music in a public area, such as a store or a shopping mall. At 310, the user uses a telephone (e.g., mobile phone or a landline-based phone) to connect to the server by, e.g., dialing a number, a short code, and the like. At 315, the call is connected to a carrier, which can be a mobile phone carrier or an IXC carrier. The carrier can then open a connection with the server, at 317 the server receives the user-initiated telephone connection. At 320, the user is connected to the server and an audio sample can be relayed by the user to the server.

While the user is tuning to various broadcast sources, at 330, the server can be receiving broadcast streams from all the broadcast sources in a geographic region, such as a city, a town, a metropolitan area, a country, or a continent. Each of the broadcast streams can be an audio channel transmitted from a particular broadcast source. For example, the geographic region can be the San Diego metropolitan area, the broadcast source can be radio station KMYI, and the audio channel can be 94.1 FM. The broadcast stream can include an audio signal, which is the audio component of the broadcast, and metadata, which is the data component of the broadcast.

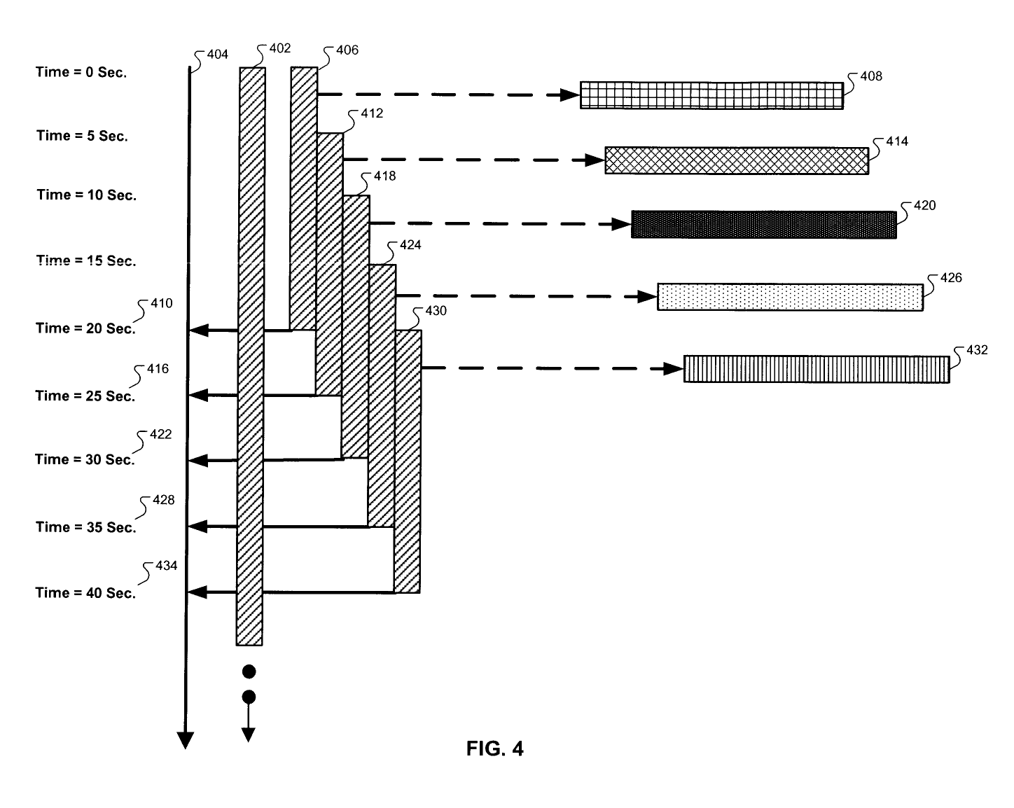

The metadata can be obtained from various broadcast formats or standards, such as a radio data system (RDS), a radio broadcast data system (RBDS), a hybrid digital (HD) radio system, a vertical blank interval (VBI) format, a closed caption format, a MediaFLO format, or a text format. At 335, the received broadcast streams are cached for a selected temporary period of time, for example, about 15 minutes. At 340, a broadcast fingerprint is generated for a predetermined portion of each of the cached broadcast streams. As an example, the predetermined portion of a broadcast stream can be between about 5 seconds and 20 seconds. In this implementation, the predetermined portion is configured to be a 20-second duration of a broadcast stream and a broadcast fingerprint is generated every 5 seconds for a 20-second duration of a broadcast stream. This concept is illustrated with reference to FIG. 4, described in detail below.

At 345, broadcast stream audio identifiers (BSAIs) are generated so that each BSAI includes a broadcast fingerprint and its associated timestamp, as well as a metadata associated with the broadcast portion (e.g., a 20-second duration) of the broadcast stream. For instance, one BSAI is generated for each timestamp and a series of BSAIs can be generated for a single broadcast stream. Thus, in a given geographic area, there can be multiple broadcast streams being cached and at each timestamp, there can be multiple BSAIs, each associated with a corresponding broadcast fingerprint of a broadcast stream.

At 352, the server receives the user-initiated telephone connection and, At 355, the server caches the audio sample, associates a user audio timestamp with the cached audio sample, and retrieves telephone information by, e.g., the SS7 protocol. The SS7 information can include the following elements: (1) an automatic number identifier (ANI, or Caller ID); (2) a carrier identification (Carrier ID) that identifies which carrier originated the call. If this is unavailable, and the user has not identified her carrier in her user profile, a local number portability (LNP) database can be used to ascertain the home carrier of the caller for messaging purposes. For example, suppose that the user's phone number is 123-456-2222, if the LNP is queried, it would say it “belongs” to T-Mobile USA. In this manner, a lookup table can be searched and an email address can be concatenated (e.g., 1234562222@tmomail.net) together and a message can be sent to that email address. This can also allow the server to know if the user is calling from a land line telephone (non-mobile) and take separate action (like sending it to an e-mail, or simply just logging it in the user's history; (3) a dialed number identification service (DNIS) that identifies what digits the user dialed (used, e.g., for segmentation of the service); (4) an automatic location identification (ALI, part of E911) or a base station number (BSN) that is associated with a specific cellular tower or a small collection of geographically bordering cellular towers. The ALI or BSN information can be used to identify what server cluster the user is located in and what pool of BSAI cache the UAI should be compared with.

In one implementation, the server assigns the user timestamp based on the time that the audio sample is cached by the server. The audio sample is a portion of the broadcast stream that the user is interested in and the portion can be a predetermine period of time, for example, a 5-20 second long audio stream. The duration of the audio sample can be configured so that it corresponds with the duration of the broadcast portion of the broadcast stream as shown in FIG. 4. At 360, the server generates a user audio fingerprint based on the cached audio sample. The user audio fingerprint can be generated similarly to that of the broadcast fingerprints. Thus, the user audio fingerprint is a unique representation of the audio sample. At 365, the server generates a user audio identifier (UAI) based on, e.g., the SS7 elements, the user audio fingerprint, and the user timestamp.

At 370, the server compares the UAI with the cached series of BSAIs to find the most highly correlated BSAI for the audio sample. At 380, the server retrieves the metadata from either the BSAI having the highest correlated broadcast fingerprint or an audio content from the backup database. As discussed above, the metadata can be retrieved from the data component of the broadcast stream. The server can also generate a user data set that includes the metadata, the user timestamp, and user data from a user profile. At 390, the server generates a message, which can be a text message (e.g., an SMS message), a multimedia message (e.g., a MMS message), an email message, or a wireless application protocol (WAP) message. This message is transmitted to the user's phone.

The amount of data and the format of the message sent by the server depends on the user's phone capability. For example, if the phone is a smartphone with Internet access, then a WAP message can be sent with embedded hyperlinks to allow the user to obtain additional information, such as a link to the artist's website, a link to download the song, and the like. The WAP message can offer other interactive information based on Carrier ID and user profile. For example, hyperlinks to download a ringtone of the song from the mobile carrier can be included. On the other hand, if the phone is a traditional landline-based telephone, the server may only send an audio message with audio prompt.

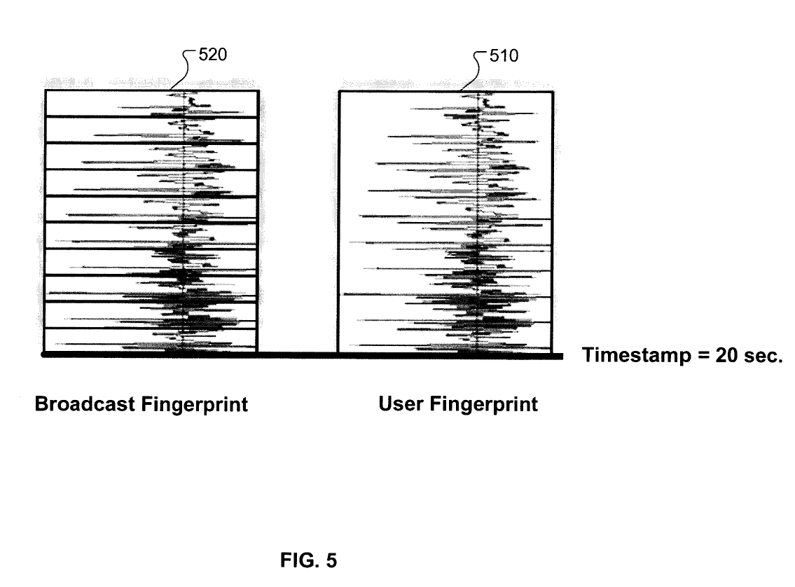

FIG. 3B is a flow chart illustrating in further detail step 370 of FIG. 3A, which compares the UAI to cached BSAIs. In this implementation, at 372, the server obtains the user timestamp (UTS) from the UAI and then queries the cached BSAIs to select a broadcast timestamp (BTS) that most closely corresponds to the user timestamp, i.e., a corresponding broadcast timestamp or CBTS. The server then retrieves all the broadcast fingerprints (BFs) having the corresponding BTS. At 374, the server compares the user fingerprint with each of the retrieved broadcast fingerprints to find the retrieved broadcast fingerprint that most closely corresponds to the user fingerprint. One implementation of this comparison is illustrated in FIG. 5, which is discussed below.

At 376, the server determines whether the highest correlation from the comparison is higher than a predefined threshold value, e.g., 20%. At 380, if the highest correlation is greater than the threshold value, then the server retrieves the metadata from the BSAI associated with the broadcast fingerprint having the highest correlation. If the highest correlation does not exceed a threshold value, at 378, the server determines whether to retrieve a broadcast timestamp earlier than the user timestamp. For example, if the user timestamp is at time=10 seconds, the server determines whether a broadcast timestamp at time=9 seconds should be retrieved. This determination can be based on a predefined configuration at the server. As an example, the server can be configured to always look for 5 seconds of timestamps prior to the user timestamp. At 378, if the server is configured to retrieve an earlier broadcast timestamp, then the process repeats at 372, with the server retrieving an earlier timestamp at 372 and retrieving another series of broadcast fingerprints associated with the earlier broadcast timestamp.

On the other hand, if the server is not configured to retrieve an earlier broadcast timestamp or if the predefined number of earlier broadcast timestamp has been reached, at 382, the server determines whether there is a backup database of audio content. The backup database can be similar to the database library of fingerprinted audio content. If a backup database is not available, at 384, then a broadcast audio identification cannot be achieved. However, if there is a backup database, at 386, the user fingerprint is compared with the backup database of fingerprints in order to find a correlation. At 388, the server determines whether the correlation is greater than a predefined threshold value. If the correlation is greater than the threshold value, at 380, the metadata for the audio content having the correlated fingerprint is retrieved. On the other hand, if the correlation does not exceed the threshold value, then the broadcast audio identification cannot be achieved at 384.

FIG. 4 illustrates conceptually a method for generating a series of broadcast fingerprints of a single broadcast stream. As shown, broadcast stream 402 is received at time=0 second of the timeline 404 and cached continuously. The predetermined portion of the broadcast stream 402 has been configured to be 20 seconds and no broadcast fingerprints will be generated from time=0 seconds to time=19 seconds. However, at time=20 seconds, there is enough of the broadcast stream 402 to assemble a broadcast portion (i.e., a 20-second duration) 406. The broadcast portion 406 of the broadcast stream 402 is processed to generate a broadcast fingerprint 408. The broadcast fingerprint 408 is a unique representation of the broadcast portion 406. Any commonly known audio fingerprinting technology can be use to generate the broadcast fingerprint 408.

Additionally, a broadcast timestamp 410 (time=20 seconds) is associated with the broadcast fingerprint 408 to denote that the broadcast fingerprint 408 was generated at time=20 seconds. At time=25 seconds, the next broadcast portion 412, which is a different 20-second duration of the broadcast stream 402, is processed to generated a broadcast fingerprint 414. Similarly, a broadcast timestamp 416 (time=25 seconds) is associated with the broadcast fingerprint 414 to denote that the broadcast fingerprint 414 was generated at time=25 seconds. The broadcast fingerprint 414 is uniquely different from the broadcast fingerprint 408 because the broadcast portion 412 is different from the broadcast portion 406.

At time=30 seconds, the next broadcast portion 418, which is another different is 20-second duration of the broadcast stream 402, is processed to generated a broadcast fingerprint 420, and a broadcast timestamp 422 (time=30 seconds) is associated with the broadcast fingerprint 420. At time=35 seconds, the next broadcast portion 424 is processed to generated a broadcast fingerprint 426, and a broadcast timestamp 428 (time=35 seconds) is associated with the broadcast fingerprint 426. At time=40 seconds, the next broadcast portion 430 is processed to generated a broadcast fingerprint 432, and a broadcast timestamp 434 (time=40 seconds) is associated with the broadcast fingerprint 432.

In this fashion, a series of additional broadcast fingerprints (not shown) can be generated for each succeeding 20-second broadcast portion of the broadcast stream 402. The broadcast stream 402 and the broadcast fingerprints (408, 414, 420, 426, 432, and 438) are then cached for a selected temporary period of time, e.g., about 15 minutes. Thus, at time=15 minute: 0 second, the 5-second portion of the broadcast stream 402 between time=0 second and time=5 second will be replaced by the incoming 5-second portion of the broadcast stream 402, in a first-in-first-out (FIFO) manner. Thus, the cache functions like a FIFO storage device and clears the first 5-second duration of the broadcast stream 402 when a new 5-second duration from time=15 minutes is cached.

Similarly, the broadcast fingerprint 408 (which has a timestamp 410 of time=20 seconds) will be replaced by a new broadcast fingerprint with a timestamp of time=15 minute: 20 seconds. In addition to broadcast stream 402, other broadcast streams (not shown) can be cached simultaneously with the broadcast stream 404. Each of these additional broadcast streams will have its own series of broadcast fingerprints with a successive timestamp indicating a 1-second interval. Thus, suppose there are five broadcast streams being cached simultaneously, at time=20 seconds, five different broadcast fingerprints will be generated; however, all these five broadcast fingerprints will have the same timestamp of time=20 seconds. Therefore, referring back to FIG. 3B, at 372, suppose that the user timestamp is time=20 seconds, then the broadcast fingerprint 408 of the broadcast stream 402 would be retrieved. Additionally, other broadcast fingerprints with a timestamp of time=20 seconds would also be retrieved.

FIG. 5 shows an example comparison of a user fingerprint 510 with one of the retrieved broadcast fingerprints 520. In this example, the user timestamp is time=20 seconds and a 20-second duration of audio sample is used to generate the user fingerprint 510. Similarly, a 20-second duration of the broadcast stream is used to generate the broadcast fingerprint 520. The correlation between the user fingerprint 510 and the broadcast fingerprint 520 does not have to be 100%; rather, the server selects the highest correlation greater than 0%. This is because the correlation is used to identify the broadcast stream and determine what metadata to send to the user.

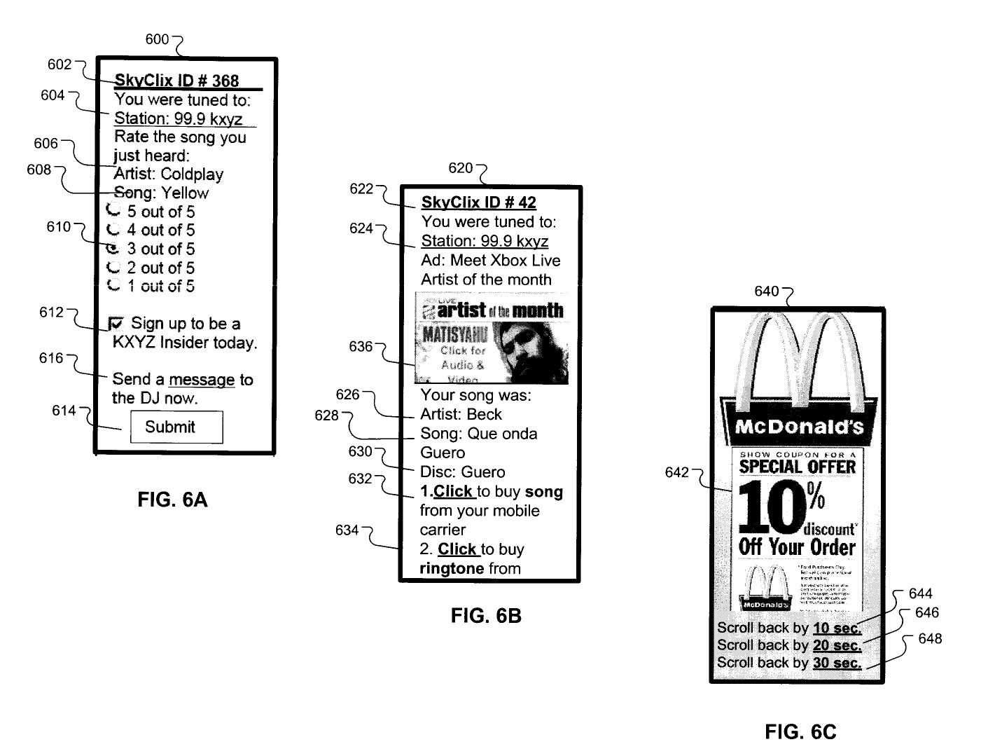

FIGS. 6A-6C illustrate exemplary messages that a server can send to a user based on the metadata of the identified broadcast stream. FIG. 6A shows an example of a WAP message 600 that allows the user to rate the audio sample and contact the broadcast source. For example, the WAP message 600 includes a message ID 602 and identifies the broadcast sources as radio station KXYZ 604. The WAP message 600 also identifies the artist 606 as “Coldplay” and the song title 608 as “Yellow.” Additionally, the user can enter a rating 610 of the identified song or sign up 612 with the radio station by clicking the “Submit” button 614. The user can also send an email message to the disc jockey (DJ) of the identified radio station by clicking on the hyperlink 616.

FIG. 6B shows an example of a WAP message 620 that allows the user to purchase the identified song or buy a ringtone directly from the phone. For example, the WAP message 620 includes a message ID 622 and identifies the broadcast sources as radio station KXYZ 624. The WAP message 620 also identifies the artist 626 as “Beck,” the song title 628 as “Que onda Guero,” and the compact disc title 630 as “Guero.” Additionally, the user can purchase the identified song by clicking on the hyperlink 632 or purchase a ringtone from the mobile carrier by clicking on the hyperlink 634. Furthermore, WAP message 620 includes an advertisement for “The artist of the month” depicted as a graphical object. The user can find out more information about this advertisement by clicking on the hyperlink 636.

FIG. 6C shows an example of a WAP message 640 that delivers a coupon to the user's phone. For example, the WAP message 640 includes a 10% discount coupon 642 for “McDonald's.” In this example, the audio sample provided by the user is an advertisement or a jingle by “McDonald's” and as the server identifies the advertisement by retrieving the metadata associated with the advertisement, the server can generate a WAP message that is targeted to interested users.

Additionally, the WAP message 640 can include a “scroll back” feature to allow the user to obtain information on a previous segment of the broadcast stream that she might have missed. For example, the WAP message 640 includes a hyperlink 644 to allow the user to scroll back to a previous segment by 10 seconds, a hyperlink 646 to allow the user to scroll back to a previous segment by 20 seconds, a hyperlink 648 to allow the user to scroll back to a previous segment by 30 seconds. Other predetermined period of time can also be provided by the WAP message 640, as long as that segment of the broadcast stream is still cached in the server. This “scroll back” feature can accommodate situations where the user just heard a couple of seconds of the broadcast stream, and by the time she dials-in or connects to the broadcast audio identification system, the broadcast info is no longer being transmitted.

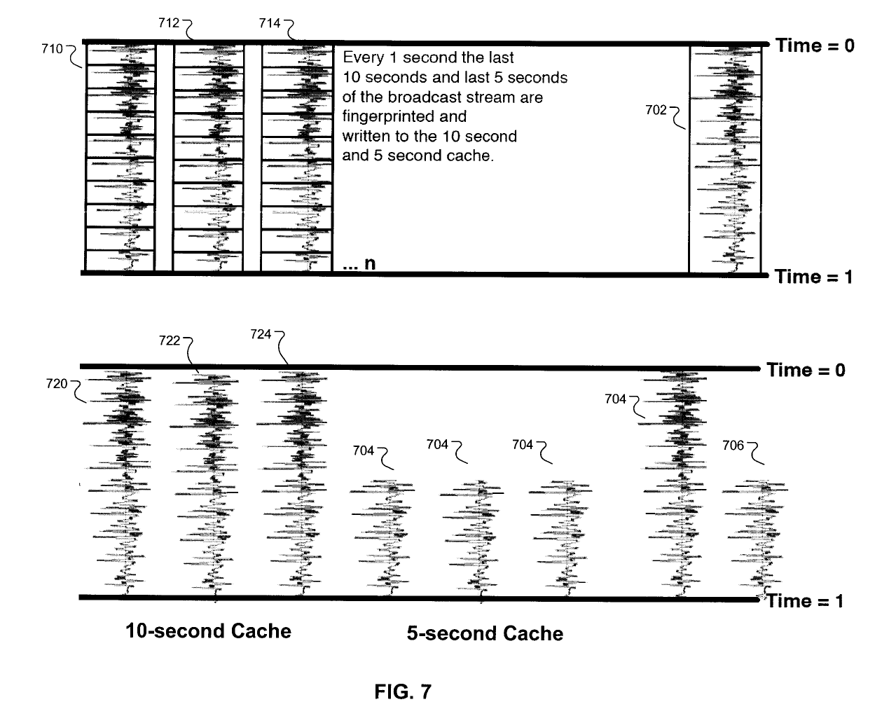

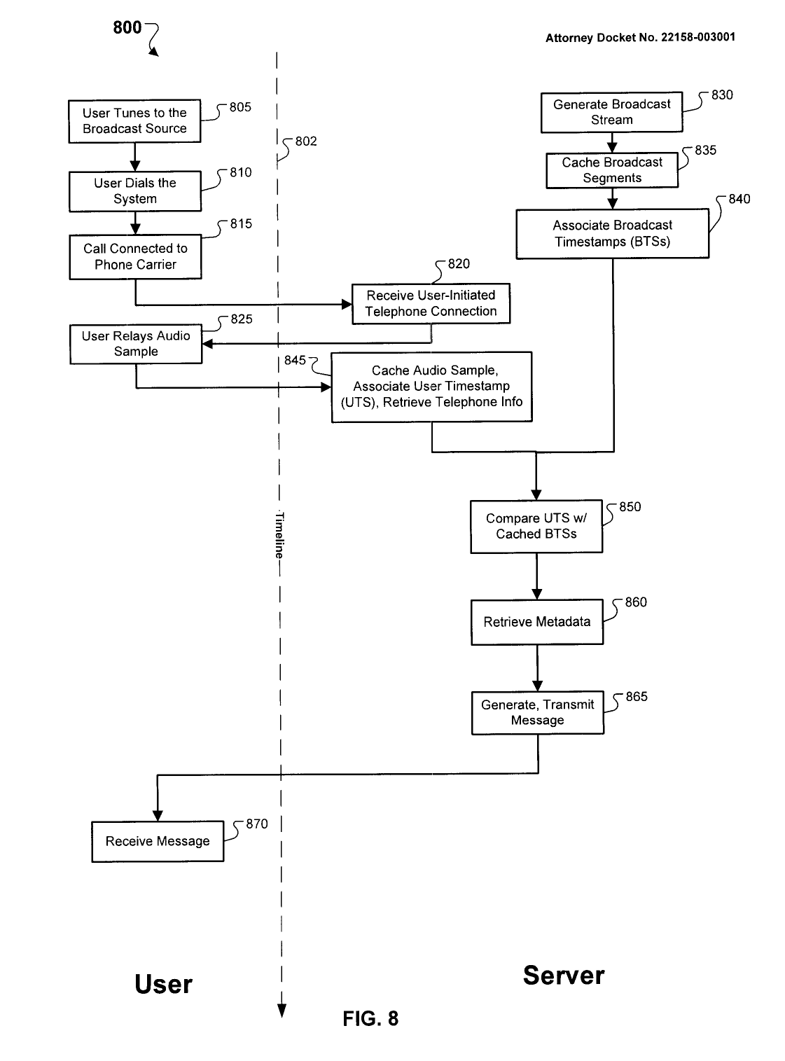

FIG. 7 shows another implementation of generating and comparing user audio fingerprints and broadcast fingerprints. As noted previously, there can be two servers for generating fingerprints: (1) the audio server, which generates and caches the user audio fingerprint; and (2) the broadcast server, which generates and caches the broadcast fingerprints. When the audio server receives a telephone call from a user (e.g., a user-initiated telephone connection), the audio server can generate two user audio fingerprints for the cached audio sample 702. As an example, suppose that the audio sample 702 provided by the user is for a 10-second duration. A first (10-second) user audio fingerprint 704 is generated based on the caching of the full 10-duration of the audio sample. Additionally, a second (5-second) user audio fingerprint 706 is generated based on the last 5 seconds of the cached audio sample 702.

Similarly, the broadcast server can generate both 5 and 10-second broadcast fingerprints from a 5-second portion and a 10-second portion of the cached broadcast streams. For example, a 10-second portion of the broadcast streams 710, 712, and 714 can be used to generate corresponding 10-second broadcast fingerprints 720, 722, and 724. Similarly, 5-second broadcast fingerprints 730, 732, and 734 can be generated from the last 5-second portion of the broadcast streams 710, 712, and 714. These 5 and 10-second broadcast fingerprints are generated every second for each broadcast stream. Timestamps are assigned to each of these broadcast fingerprints at every second. Thus, there would be a series of 5-second broadcast fingerprints and a series of 10-second broadcast fingerprints. These two series of broadcast fingerprints are then stored in different caches, with the 5-second broadcast fingerprints being stored in a 5-second cache and a 10-second broadcast fingerprint being stored in a 10-second cache. As a result, there are two caches of fingerprints of the whole broadcast spectrum being monitored by the server with a resolution of 1 second.

For example, on a system monitoring 30 broadcast streams, there will be a cache of 3,600 broadcast fingerprints per minute being generated (30 broadcast streams×60 seconds×2 types of fingerprints). When the audio server finishes caching the audio sample provided by the user and terminates the call at, e.g., Time=1, a timestamp is generated for the user audio fingerprints. The 10-second broadcast fingerprints are then searched for a match at the same timestamp, i.e., Time=1. If the 10-second user fingerprint fails to match anything in the 10-second broadcast fingerprint cache for the same timestamp, the 5-second user fingerprint (the last 5 seconds of the audio sample) is then used to search the 5 second broadcast fingerprint cache for a match at the same timestamp of Time=1. If there is no match against either of the broadcast fingerprint caches, the network operations center is notified and according to the business rules for that market, other searches (e.g., using a backup database) can be performed.

FIG. 8 is a flow chart showing another method 800 for providing broadcast audio identification based on audio samples obtained from a broadcast stream provided by a user through a user-initiated connection, such as by dialing-in. The broadcast audio identification system can be implemented by a broadcast source. In this case, there is one broadcast stream to be identified and the broadcast source already has information on the broadcast stream being transmitted. The steps of method 800 are shown in reference to a timeline 802; thus, two steps that are at the same vertical position along timeline 802 indicates that the steps can be performed at substantially the same time. In other implementations, the steps of method 800 can be performed in different order and/or at different times.

In this implementation, however, at 805, a user tunes to a broadcast source to receive a broadcast audio stream transmitted by the broadcast source. This broadcast source can be a pre-set radio station that the user likes to listen to or it can be a television station that she just tuned in. Alternatively, the broadcast source can be a location broadcast that provides background music in a public area, such as a store or a shopping mall. At 810, the user uses a telephone (e.g., mobile phone or a landline-based phone) to connect to the server of the broadcast source by, e.g., dialing a number, a short code, and the like. Additionally, the user can dial a number assigned to the broadcast source; for example, if the broadcast source is a radio station transmitting at 94.1 FM, the user can simply dial “*941” to connect to the server. At 815, the call is connected to a carrier, which can be a mobile phone carrier or an IXC carrier. The carrier can then open a connection with the server, at 820 the server receives the user-initiated telephone connection. At 825, the user is connected to the server and an audio sample can be relayed by the user to the server.

While the user is tuning to the broadcast source, at 830, the server can be generating the broadcast stream to be transmitted by the broadcast source. In another implementation, instead of generating the broadcast stream, the server can simply obtain the broadcast stream, such as where the server is not part of the broadcast source's system. The broadcast stream can include many broadcast segments, each segment being a predetermined portion of the broadcast stream. For example, a broadcast segment can be a 5-second duration of the broadcast stream. The broadcast stream can also include an audio signal, which is the audio component of the broadcast, and metadata, which is the data component of the broadcast. The metadata can be obtained from various broadcast formats or standards, such as those discussed above.

At 835, the generated broadcast segments are cached for a selected temporary period of time, for example, about 15 minutes. At 840, a broadcast timestamp (BTS) is associated with each of the cached broadcast segment. At 820, the server receives the user-initiated telephone connection and, At 845, the server caches the audio sample, associates a user timestamp (UTS) with the cached audio sample, and retrieves telephone information by, e.g., the SS7 protocol. In one implementation, the server assigns the user timestamp based on the time that the audio sample is cached by the server. The audio sample is a portion of the broadcast stream that the user is interested in and the portion can be a predetermine period of time, for example, a 5-20 second long audio stream. The duration of the audio sample can be configured so that it corresponds with the duration of the broadcast segment of the broadcast stream.

At 850, the server compares the UTS with the cached BTSs to find the most highly correlated BTS. Once the highest correlated BST is selected, its associated broadcast segment can be retrieved. Thus, the broadcast audio can be identified simply by using the user timestamp. At 860, the server retrieves the metadata from the broadcast segment having the highest correlated BTS. As discussed above, the metadata can be retrieved from the data component of the broadcast stream. The server can also generate a user data set that includes the metadata, the user timestamp, and user data from a user profile. At 865, the server generates a message, such as any of those discussed above. This message is transmitted to the user's phone and received by the user at 870.

Various implementations of the subject matter described herein can be realized in digital electronic circuitry, integrated circuitry, specially designed ASICs (application specific integrated circuits), computer hardware, firmware, software, and/or combinations thereof. These various implementations can include implementations in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the term “memory” comprises a “computer-readable medium” that includes any computer program product, apparatus and/or device (e.g., magnetic discs, optical disks, RAM, ROM, registers, cache, flash memory, and Programmable, Logic Devices (PLDs)) used to provide machine instructions and/or data to a programmable processor, including a machine-readable medium that receives machine instructions as a machine-readable signal, as well as a propagated machine-readable signal. The term “machine-readable signal” refers to any signal used to provide machine instructions and/or data to a programmable processor.

While many specifics implementations have been described, these should not be construed as limitations on the scope of the subject matter described herein or of what may be claimed, but rather as descriptions of features specific to particular implementations. Certain features that are described herein in the context of separate implementations can also be implemented in combination in a single implementation. Conversely, various features that are described in the context of a single implementation can also be implemented in multiple implementations separately or in any suitable subcombination. Moreover., although features may be described above as acting in certain combinations and even initially claimed as such, one or more features from a claimed combination can in some cases be excised from the combination, and the claimed combination may be directed to a subcombination or variation of a subcombination.

Similarly, while operations or steps are depicted in the drawings in a particular order, this should not be understood as requiring that such operations or steps be performed in the particular order shown or in sequential order, or that all illustrated operations or steps be performed, to achieve desirable results. In certain circumstances, multitasking and parallel processing may be advantageous. Moreover, the separation of various system components in the implementations described above should not be understood as requiring such separation in all implementations.

Although a few variations have been described in detail above, other modifications are possible. Accordingly, other implementations are within the scope of the following claims. For example, the actions recited in the claims can be performed in a different order and still achieve desirable results.

What is claimed is:

1. A method comprising:
receiving a plurality of broadcast streams, each from a corresponding broadcast source;
generating a first broadcast audio identifier based on a first broadcast stream of the plurality of broadcast streams;
storing for a selected temporary period of time the first broadcast audio identifier;
receiving a user-initiated telephone connection; and
generating a user audio identifier.

2. The method of claim 1, further comprising reporting periodically a status of receiving the plurality of broadcast streams.

3. The method of claims 1., wherein generating the user audio identifier comprises:
receiving an audio sample through the user-initiated telephone connection for a predetermined period of time;
generating a user audio fingerprint of the audio sample;
associating a user audio timestamp with the user audio fingerprint; and
retrieving telephone information through the user-initiated telephone connection.

4. The method of claim 1, wherein the selected temporary period of time is less than about 20 minutes.

5. The method of claim 1, wherein the corresponding broadcast source is one selected from a group of a radio station, a television station, an Internet website, an Internet service provider, a cable television station, a satellite radio station, a shopping mall, and a store.

6. The method of claim 1, further comprising:
generating a second broadcast audio identifier based on the first broadcast stream;
generating a third broadcast audio identifier based on a second broadcast stream of the plurality of broadcast streams; and
storing for the selected temporary period of time the second and the third broadcast audio identifiers.

7. The method of claim 6, wherein generating the first broadcast audio identifier based on the first broadcast stream of the plurality of broadcast streams comprises:
generating a first broadcast fingerprint of a first portion of the first broadcast stream;
retrieving a first metadata from the first portion of the first broadcast stream; and
associating a first broadcast timestamp with the first broadcast fingerprint.

8. The method of claim 7, wherein generating the second broadcast audio identifier based on the first broadcast stream of the plurality of broadcast streams comprises:
generating a second broadcast fingerprint of a second portion of the first broadcast stream;
retrieving a second metadata from the second portion of the first broadcast stream; and
associating a second broadcast timestamp with the second broadcast fingerprint.

9. The method of claim 8, wherein generating the third broadcast audio identifier based on the second broadcast stream of the plurality of broadcast streams comprises:
generating a third broadcast fingerprint of a first portion of the second broadcast stream;
retrieving a third metadata from the first portion of the second broadcast stream; and
associating the first broadcast timestamp with the third broadcast fingerprint.

10. The method of claim 9, further comprising:
retrieving either the first broadcast audio identifier, the second broadcast audio identifier, or the third broadcast audio identifier that most closely corresponds to the user audio identifier.

11. The method of claim 9, wherein generating the user audio identifier comprises:
receiving an audio sample through the user-initiated telephone connection for a predetermined period of time;
generating a user audio fingerprint of the audio sample;
associating a user audio timestamp with the user audio fingerprint; and
retrieving telephone information through the user-initiated telephone connection.

12. The method of claim 9, wherein the second broadcast timestamp is separated from the first broadcast timestamp by a time interval.

13. The method of claim 12, wherein the time interval is about 5 seconds.

14. The method of claim 10, further comprising:
obtaining a metadata selected from the group of the first, the second, and the third metadata associated with the retrieved broadcast audio identifier; and
transmitting a message based on the obtained metadata.

15. The method of claim 14, wherein the message is one selected from a group of a text message, an e-mail message, a multimedia message, an audio message, a wireless application protocol message, and a data feed.

16. The method of claim 9, wherein the first metadata, the second metadata, and the third metadata, each comprises metadata provided by a metadata source.

17. The method of claim 16, wherein the metadata source is one selected from a group of a radio broadcast data standard (RBDS) broadcast stream, a radio data system (RDS) broadcast stream, a high definition radio broadcast stream, a vertical blanking interval (VBI) broadcast stream, a digital audio broadcasting (DAB) broadcast stream, a MediaFLO broadcast stream, and a closed caption broadcast stream.

18. The method of claim 11, wherein the predetermined period of time is less than about 25 seconds.

19. The method of claim 11, wherein the telephone information comprises at least one selected from a group of an automatic number identifier (ANI), a carrier identifier (Carrier ID), a dialed number identification service (DNIS), an automatic location identification (ALI), and a base station number (BSN).

20. The method of claim 11, further comprising selecting either the first broadcast fingerprint, the second broadcast fingerprint, or the third broadcast fingerprint that most closely corresponds to the user fingerprint.

21. The method of claim 20, wherein selecting either the first broadcast fingerprint, the second broadcast fingerprint, or the third broadcast fingerprint that most closely corresponds to the user fingerprint comprises:
selecting either the first broadcast timestamp or the second broadcast timestamp that most closely corresponds to the user timestamp;
retrieving each broadcast fingerprint associated with the selected broadcast timestamp;
comparing each retrieved broadcast fingerprint to the user fingerprint; and
retrieving one of the compared broadcast fingerprints that most closely corresponds to the user fingerprint.

22. A method comprising:
generating a broadcast stream comprised of more than one broadcast segment, each broadcast segment including metadata;
associating each broadcast segment with a broadcast timestamp;
receiving a user-initiated telephone connection; and
generating a user audio identifier.

23. The method of claim 22, wherein generating the user audio identifier comprises:
receiving an audio sample through the user-initiated telephone connection for a predetermined period of time;
associating a user audio timestamp with the audio sample; and
retrieving telephone information through the user-initiated telephone connection.

24. The method of claim 23, wherein the predetermined period of time is less than about 25 seconds.

25. The method of claim 23, wherein the telephone information comprises at least one selected from a group of an automatic number identifier (ANI), a carrier identifier (Carrier ID), a dialed number identification service (DNIS), an automatic location identification (ALI), and a base station number (BSN).

26. The method of claim 23, further comprising:
selecting one of the associated broadcast timestamps that most closely corresponds to the user audio timestamp; and
retrieving the broadcast segment associated with the selected broadcast timestamp.

27. The method of claim 26, further comprising:
obtaining the metadata from the retrieved broadcast segment; and
transmitting a message based on the obtained metadata.

28. The method of claim 27, wherein the transmitted message is one selected from a group of a text message, an e-mail message, a multimedia message, an audio message, a wireless application protocol message, and a data feed.

29. The method of claim 22, wherein the metadata is provided by either a radio broadcast data standard (RBDS) broadcast stream, a radio data system (RDS) broadcast stream, a high definition radio broadcast stream, a vertical blanking interval (VBI) broadcast stream, a digital audio broadcasting (DAB) broadcast stream, a MediaFLO broadcast stream, or a closed caption broadcast stream.

30. A method comprising:
obtaining a broadcast stream comprised of more than one broadcast segment, each broadcast segment including metadata;
associating each broadcast segment with a broadcast timestamp;
receiving a user-initiated telephone connection; and
generating a user audio identifier.

31. The method of claim 30, wherein generating the user audio identifier comprises:
receiving an audio sample through the user-initiated telephone connection for a predetermined period of time;
associating a user audio timestamp with the audio sample; and
retrieving telephone information through the user-initiated telephone connection.

32. The method of claim 31, wherein the predetermined period of time is less than about 25 seconds.

33. The method of claim 31, wherein the telephone information comprises at least one selected from a group of an automatic number identifier (ANI), a carrier identifier (Carrier ID), a dialed number identification service (DNIS), an automatic location identification (ALI), and a base station number (BSN).

34. The method of claim 31, further comprising:
selecting one of the associated broadcast timestamps that most closely corresponds to the user audio timestamp; and
retrieving the broadcast segment associated with the selected broadcast timestamp.

35. The method of claim 34, further comprising:
obtaining the metadata from the retrieved broadcast segment; and
transmitting a message based on the obtained metadata.

36. The method of claim 35, wherein the transmitted message is one selected from a group of a text message, an e-mail message, a multimedia message, an audio message, a wireless application protocol message, and a data feed.

37. The method of claim 36, wherein the metadata is provided by either a radio broadcast data standard (RBDS) broadcast stream, a radio data system (RDS) broadcast stream, a high definition radio broadcast stream, a vertical blanking interval (VBI) broadcast stream, a digital audio broadcasting (DAB) broadcast stream, a MediaFLO broadcast stream, or a closed caption broadcast stream.

38. A system comprising:
a broadcast server;
a computer program product stored on one or more computer readable mediums, the computer program product including a first plurality of executable instructions configured to cause the broadcast server to perform a first plurality of operations comprising:
receiving a plurality of broadcast streams, each from a corresponding broadcast source;
generating a first broadcast audio identifier based on a first broadcast stream of the plurality of broadcast streams; and
storing for a selected temporary period of time the first broadcast audio identifier.

39. The system of claim 38, further comprising an audio server configured to communicate with the broadcast server.

40. The system of claim 38, wherein the computer program product further including a second plurality of executable instructions configured to cause the audio server to perform a second plurality of operations comprising:
receiving a user-initiated telephone connection; and
generating a user audio identifier.

41. The system of claim 38, wherein the operation generating the user audio identifier comprises:
receiving an audio sample through the user-initiated telephone connection for a predetermined period of time;
generating a user audio fingerprint of the audio sample;
associating a user audio timestamp with the user audio fingerprint; and
retrieving telephone information through the user-initiated telephone connection.

42. The system of claim 38, wherein the first plurality of operations further comprising:
generating a second broadcast audio identifier based on the first broadcast stream;
generating a third broadcast audio identifier based on a second broadcast stream of the plurality of broadcast streams; and
storing for the selected temporary period of time the second and the third broadcast audio identifiers.

43. The system of claim 42, wherein the operation generating the first broadcast audio identifier based on the first broadcast stream of the plurality of broadcast streams comprises:
generating a first broadcast fingerprint of a first portion of the first broadcast stream;
retrieving a first metadata from the first portion of the first broadcast stream; and
associating a first broadcast timestamp with the first broadcast fingerprint.

44. The system of claim 43, wherein the operation generating the second broadcast audio identifier based on the first broadcast stream of the plurality of broadcast streams comprises:
generating a second broadcast fingerprint of a second portion of the first broadcast stream;
retrieving a second metadata from the second portion of the first broadcast stream; and
associating a second broadcast timestamp with the second broadcast fingerprint.

45. The system of claim 44, wherein the operation generating the third broadcast audio identifier based on the second broadcast stream of the plurality of broadcast streams comprises:
generating a third broadcast fingerprint of a first portion of the second broadcast stream;
retrieving a third metadata from the first portion of the second broadcast stream; and
associating the first broadcast timestamp with the third broadcast fingerprint.

46. The system of claim 45, wherein the first plurality of operations further comprising:
retrieving either the first broadcast audio identifier, the second broadcast audio identifier, or the third broadcast audio identifier that most closely corresponds to the user audio identifier.

47. The system of claim 46, further comprising a commerce server configured to communicate with the broadcast server.

48. The system of claim 47, wherein the computer program product further including a third plurality of executable instructions configured to cause the commerce server to perform a third plurality of operations comprising:
transmitting a message to a user based on the retrieved broadcast audio identifier.
